(19) United States
(12) Patent Application Publication
(10) Pub. No.: US 2026/0032640 A1
(43) Pub. Date: Jan. 29, 2026

(54) SYSTEMS, METHODS, AND DEVICES FOR ADAPTIVE PAGING EARLY INDICATION (PEI)

(71) Applicant: Apple Inc., Cupertino, CA (US)

(72) Inventors: Junzhen QIN, Beijing (CN); Lijie ZHANG, Beijing (CN); Qiang MIAO, Beijing (CN); Ying ZHANG, Beijing (CN); Zhiwei WANG, Beijing (CN)

(21) Appl. No.: 19/281,514

(22) Filed: Jul. 25, 2025

Related U.S. Application Data
(60) Provisional application No. 63/676,650, filed on Jul. 29, 2024.

(51) Int. Cl. H04W 68/02

(52) U.S. Cl. CPC H04W 68/02

(57) ABSTRACT

The techniques described herein can include solutions for adaptive paging early indication (PEI). For example, a user equipment (UE) can determine whether to enable or disable monitoring of PEI occasions. In some examples, the UE can enable or disable monitoring of PEI occasions based on intervals between SSBs, PEI occasions, and paging occasions. In some examples, the UE can initiate determination of enabling or disabling monitoring of PEI in response to receiving communications or reselecting an SSB. In some examples, the UE can enable or disable monitoring of PEI occasions based on the frequency of paging occasions and paging occasions thresholds. In some examples, the UE can refrain from decoding pre-sync SSBs prior to PEI occasions, paging occasions, or both.

### CROSS-REFERENCE TO RELATED APPLICATIONS

This application claims the benefit of U.S. Provisional Application No. 63/676,650, filed Jul. 29, 2024, the content of which is herein incorporated by reference in its entirety for all purposes.

### FIELD

This disclosure relates to wireless communication networks and mobile device capabilities.

### BACKGROUND

Wireless communication networks and wireless communication services are becoming increasingly dynamic, complex, and ubiquitous. For example, some wireless communication networks can be developed to implement fourth generation (4G), fifth generation (5G) or new radio (NR) technology. Such technology can include solutions for enabling user equipment (UE) and network devices, such as base stations, to communicate with one another. Some scenarios can involve indicating messages to a UE.

### BRIEF DESCRIPTION OF THE DRAWINGS

The present disclosure will be readily understood and enabled by the detailed description and accompanying figures of the drawings. Like reference numerals cam designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and can mean at least one, one or more, etc.

FIG. 1 is a diagram of an example of an overview according to one or more implementations described herein.

FIG. 2 is a diagram of an example network according to one or more implementations described herein.

FIG. 3 is a diagram of an example process for adaptive paging early indication (PEI) according to one or more implementations described herein.

FIG. 4 is a diagram of an example process for adaptive PEI according to one or more implementations described herein.

FIG. 5 is a diagram of an example for adaptive PEI according to one or more implementations described herein.

FIG. 6 is a diagram of an example for adaptive PEI according to one or more implementations described herein.

FIG. 7 is a diagram of an example process for adaptive PEI according to one or more implementations described herein.

FIG. 8 is a diagram of an example of components of a device according to one or more implementations described herein.

FIG. 9 is a diagram of example interfaces of baseband circuitry according to one or more implementations described herein.

FIG. 10 is a block diagram illustrating components, according to one or more implementations described herein, able to read instructions from a machine-readable or computer-readable medium (e.g., a non-transitory machine-readable storage medium) and perform any one or more of the methodologies discussed herein.

FIG. 11 is a diagram of an example process for adaptive PEI according to one or more implementations described herein.

FIG. 12 is a diagram of an example process for adaptive PEI according to one or more implementations described herein.

### DETAILED DESCRIPTION

The following detailed description refers to the accompanying drawings. Like reference numbers in different drawings can identify the same or similar features, elements, operations, etc. Additionally, the present disclosure is not limited to the following description as other implementations can be utilized, and structural or logical changes made, without departing from the scope of the present disclosure.

Telecommunication networks can include user equipment (UEs) capable of communicating with base stations and/or other network access nodes. UEs and base stations can implement various techniques and communications standards for enabling UEs and base stations to discover one another, establish and maintain connectivity, and exchange information in an ongoing manner. Objectives of such techniques can include adapting paging early indications (PEI) according to power consumption.

A UE can operate in various energy states, such as an idle/inactive (collectively referred to herein as idle state) state or an active state. While in the idle state, the UE conserves power, and while in the active state, the UE receives communications from the base station. The UE may transition from an idle state to an active state to receive communications. For example, the UE can enter an active state to receive synchronization signal blocks (SSBs) that indicate to the UE information about communicating with the base station. Paging messages can be sent during paging occasions by the base station when the UE is in the idle state to notify the UE of upcoming messages that require the UE to be in an active state.

In some examples, the base station can transmit a paging early indication (PEI) to notify the UE in advance of paging occasions. In order to receive the PEI, the UE can pre-sync by monitoring for and decoding an SSB. The UE, while in an idle state, can monitor for the PEI. If the UE detects and decodes the PEI, the UE monitors for and decodes the next paging occasion. If the UE does not detect or decode the PEI, the UE can remain in an idle state and skip detecting and decoding the next paging occasion, resulting in power savings. The PEI can be signaled via downlink (DL) control information (DCI) via the physical DL control channel (PDCCH), or via a reference signal (RS).

However, various factors can affect the amount of power saved, such as the interval between the PEI and SSB, and the interval between the PEI and paging occasion (PO). For example, if the PEI and SSB are farther apart, the UE enters and exits sleep states inefficiently in order to decode the signals. The interval between the PEI and the PO can affect power savings and cost similarly. Another factor can be the paging rate (e.g., how often the UE receives PEIs). That is, it may be inefficient for the UE to monitor for and decode PEIs if there is a higher paging rate. Thus, in some scenarios, implementing PEIs may not result in power savings or an advantage for the UE.

One or more of the techniques described herein address the foregoing deficiencies by providing solutions for adaptive PEI that can involve adjusting PEI monitoring and skipping pre-syncing. For example, the UE can disable or enable PEI monitoring according to network configuration factors, such as a power value, SSB reselection, and paging rate. The UE can calculate a power value by comparing the interval between the SSB and PEI, and the interval between the SSB and PO. In some examples, the UE can reselect an SSB and can calculate a power value based on the reselected SSB. Based on the power value, the UE can determine whether to enable or disable PEI monitoring. In some examples, the UE can calculate a paging rate threshold, and enable or disable PEI monitoring based on the paging rate in relation to the paging rate threshold. In some examples, the UE can refrain from pre-syncing prior to receiving PEI messages. For example, the UE can skip pre-syncing before PEI decoding when there is a PEI decoding failure. Adjusting PEI monitoring and skipping pre-syncing can result in power savings for the UE.

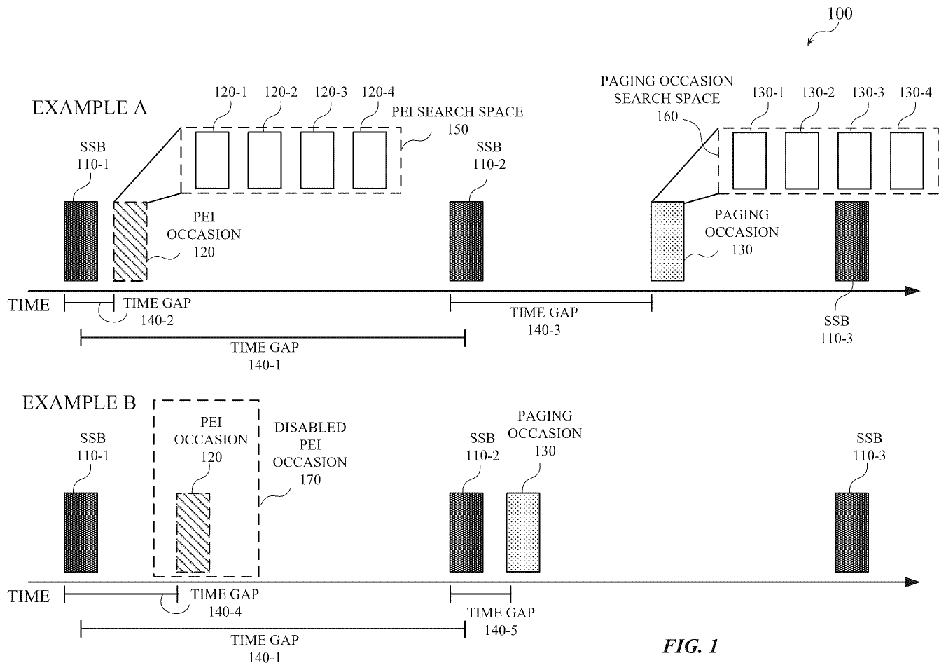

FIG. 1 is a diagram of an example of an overview 100 adaptive PEI according to one or more implementations described herein. As shown, a UE can receive communications from a base station. UE can monitor for and decode the communications from the base station. For example, UE can monitor for and decode SSB 110, monitor PEI occasion 120 and decode the PEI, and monitor paging occasion 130 and decode the paging message.

SSB 110-1 and PEI occasion 120 can be separated by time gap 140-2. SSB 110-1 and SSB 110-2 can be separated by time gap 140-1, which is the same as the time gap 140-1 between SSB 110-2 and 110-3. The UE can pre-sync prior to PEI occasion 120 by decoding SSB 110-1 and can pre-sync prior to paging occasion 130 by decoding SSB 110-2. Pre-synching can synchronize timing and frequency in order to provide better conditions for protentional paging decoding, such as for physical DL shared channel (PDSCH) paging decoding. For an SSB-based pre-sync, the UE can wake up to decode SSB 110-1, resulting in power consumption.

A time gap 140 between SSB 110-1 and PEI occasions 120 can vary, which can affect UE power use and efficiency. For example, with reference to Example A, SSB 110-1 and PEI occasion 120 can be separated by time gap 140-2. With reference to Example B, SSB 110-1 and PEI occasion 120 can be separated by time gap 140-4, which can be larger than time gap 140-2. Similarly, a time gap between SSB 110-2 and paging occasions 130 can vary, affecting UE power use and efficiency. For example, with reference to Example A, SSB 110-2 and paging occasion 130 can be separated by time gap 140-3, which can be larger than time gap 140-5 between SSB 110-2 and paging occasion 130 of Example B.

Example B describes a long interval between SSB 110-1 and PEI occasion 120, and a short interval between SSB 110-2 and paging occasion 130. In such an example, a PEI frame offset parameter can be set to a smaller value (e.g., pei-FrameOffset-r17=1) than a paging frame offset parameter (e.g., nAndPaingFramOffset->oneT=2). The differences in intervals can result in the PEI decoding consuming more power than direct paging decoding. In such scenarios, PEI decoding can include the pre-sync decoding of SSB 110-1, resulting in higher power overhead due to the larger time gap 140-4. For example, the UE can remain in an active state for the duration of time gap 140-4, which is a longer duration than time gap 140-2 of Example A, resulting in greater power consumption. If the PEI occasion 120 were removed, or disabled, as shown by disabled PEI occasion 170, the UE may not remain in an active state for time gap 140-4. Thus, in Example B, it can be advantageous not to monitor for and decode SSB 110-1. Disabled PEI occasion 170 can also be advantageous due to the shorter duration of time gap 140-5, which enables the UE to enter an active state to monitor for and receive SSB 110-2 and paging occasion 130 and quickly return to an idle state.

Table 1 describes Examples A and B with and without PEI occasions 120. Table 1 describes an example paging rate of 18.35%. Table 1 describes the effect of enabling/disabling PEI occasion 120 monitoring and decoding for various discontinuous reception (DRX) cycles. Time gap 140-1 can be 20 milliseconds (ms), time gap 140-2 can be 2 ms, time gap 140-3 can be 10 ms, time gap 140-4 can be 5 ms, and time gap 140-5 can be 2 ms. For Example B, monitoring PEI occasion 120 results increased power consumption and reduced power savings.

TABLE 1

| | | Example A | | Example B | |
|---|---|---|---|---|---|
| | DRX | Power | Power Saving | Power | Power Saving |
| PEI | 640 | 1.563 | | 1.3438 | |
| Disabled | 1280 | 1.9481 | | 0.939 | |
| | 2560 | 0.7241 | | 0.6695 | |
| | 5120 | 0.6074 | | 0.5802 | |
| PEI | 640 | 1.4661 | 6.2% | 1.5202 | −13.13% |
| Enabled | 1280 | 1.0002 | 4.57% | 1.0192 | −8.54 |
| | 2560 | 0.7001 | 3.31% | 0.7096 | 5.99% |
| | 5120 | 0.5954 | 1.98% | 0.6002 | −3.54% |

In some examples, PEI occasions 120 and paging occasion 130 can have multiple occasions with a search space. For example, PEI occasion 120 can include multiple occasions within PEI search space 150. Paging occasion 130 can include multiple occasions within paging occasion search space 160. SSB 110 can indicate which portion of the search space to monitoring for the occasion. For example, SSB 110-1 can indicate to search a first PEI occasion 120-1 of PEI search space 150, which corresponds to paging occasion 130-1 of the paging occasion search space 160.

When there is SSB re-selection, there can be a change to time gaps 140, or intervals between SSB 110-1 and PEI occasion 120 and the interval between SSB 110-2 and paging occasion 130. In such examples, reselected SSB 110 can indicate to search different portions of the search spaces than a previously selected SSB 110. Switching from the first SSB to the second SSB can result in a change of the intervals due to the difference in time between the different portions of the search space, which can result in power inefficiencies. For example, the reselected SSB 110 can indicate to search PEI occasion 120-3 and paging occasion 130-3, which are farther away from their respective SSBs 110.

For example, Table 2 describes power saving with regard to monitoring either PEI occasion 120-1 and paging occasion 130-1 or PEI occasion 120-3 and paging occasion 130-3. Monitoring the third occasions results in greater power savings for UE.

TABLE 2

| | | Monitoring the First | | Monitoring the Third | |
|---|---|---|---|---|---|
| | | Occasions of the | | Occasion of the | |
| | | Search Spaces | | Search Spaces | |
| | DRX | Power | Power Saving | Power | Power Saving |
| PEI | 640 | 1.3161 | | 1.5364 | |
| Disabled | 1280 | 0.9298 | | 1.0294 | |
| | 2560 | 0.6649 | | 0.7147 | |
| | 5120 | 0.5778 | | 0.6027 | |
| PEI | 640 | 1.3913 | −5.71% | 1.5185 | 1.17% |
| Enabled | 1280 | 0.9674 | −4.04% | 1.0172 | 1.19% |
| | 2560 | 0.6837 | −2.83% | 0.7086 | 0.85% |
| | 5120 | 0.5872 | −1.63% | 0.5997 | 0.50% |

In some examples, the UE can monitor PEI occasions 120 according to a paging rate. For example, the UE can monitor every other paging occasion 120, resulting in a paging rate of 50%, or every fourth PEI occasion 130, resulting in a paging rate of 25%. A higher paging rate, or monitoring paging occasion 130 with higher frequency, can increase power use. Table 3 describes the effects of varying paging rates on power savings. Reducing the paging rate can result in power savings.

TABLE 3

| | | Paging rate of 5% | | Paging rate of 18.35% | | Paging rate of 50%. | |
|---|---|---|---|---|---|---|---|
| | | | Power | | Power | | Power |
| | DRX | Power | Saving | Power | Saving | Power | Saving |
| PEI | 640 | 1.5630 | | 1.5630 | | 1.5630 | |
| Disabled | 1280 | 1.0481 | | 1.0481 | | 1.0481 | |
| | 2560 | 0.7241 | | 0.7241 | | 0.7241 | |
| | 5120 | 0.6074 | | 0.6074 | | 0.6074 | |
| PEI | 640 | 1.3771 | 11.89% | 1.4661 | 6.2% | 1.6771 | −7.30% |
| Enabled | 1280 | 0.9557 | 8.82% | 1.0002 | 4.57% | 1.1056 | −5.49% |
| | 2560 | 0.6778 | 6.39% | 0.7001 | 3.31% | 0.7528 | −3.96% |
| | 5120 | 0.5843 | 3.8% | 0.5954 | 1.98% | 0.6218 | −2.37% |

Techniques described herein can be applied to increase power savings through adaptive PEI. For example, the UE can determine whether to enabling monitoring of PEI occasion 120 or to disable monitoring of PEI occasions. The UE can use various power factors, such as paging rate, to adjust PEI occasion 120 monitoring. For example, for some configurations and high paging rate, there is a power cost to the UE (e.g., Table 3, paging rate of 50%). In such examples, it can be advantageous to skip PEI monitoring occasion 120, as shown by disabled PEI occasion 170. In some examples, the UE can determine whether to skip pre-syncing to reduce power consumption and increase power savings. Such techniques and many other features and aspects of the techniques described herein are presented below with reference to remaining Figures.

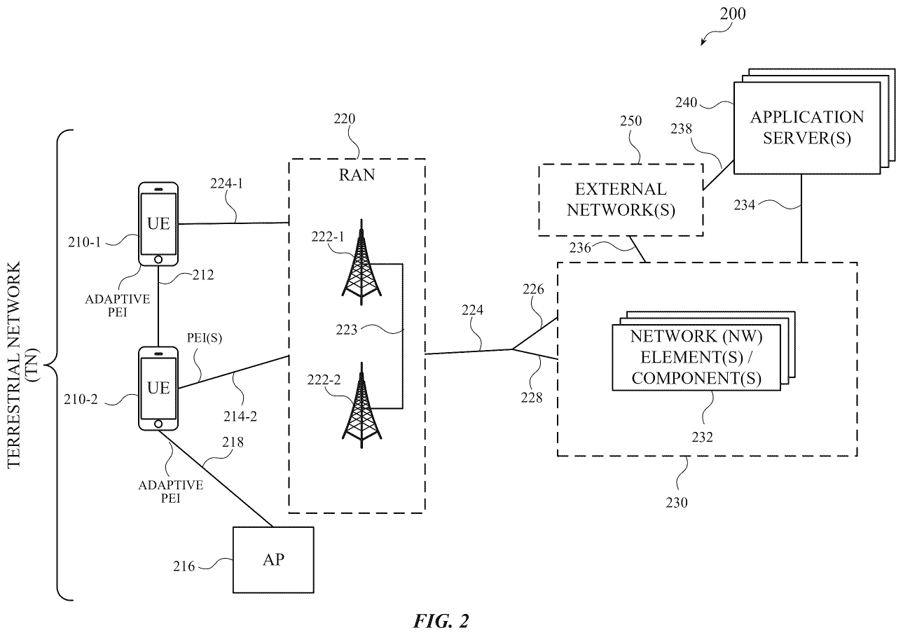

FIG. 2 is an example network 200 according to one or more implementations described herein. Example network 200 can include UEs 210, 210-2, etc. (referred to collectively as “UEs 210” and individually as “UE 210”), a radio access network (RAN) 220, a core network (CN) 230, application servers 240, and external networks 250.

The systems and devices of example network 200 can operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 200 can operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 210 can include smartphones (e.g., handheld touchscreen mobile computing devices connectable to one or more wireless communication networks). Additionally, or alternatively, UEs 210 can include other types of mobile or non-mobile computing devices capable of wireless communications, such as personal data assistants (PDAs), pagers, laptop computers, desktop computers, wireless handsets, etc. In some implementations, UEs 210 can include internet of things (IoT) devices (or IoT UEs) that can comprise a network access layer designed for low-power IoT applications utilizing short-lived UE connections. Additionally, or alternatively, an IoT UE can utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data can be a machine-initiated exchange, and an IoT network can include interconnecting IoT UEs (which can include uniquely identifiable embedded computing devices within an Internet infrastructure) with short-lived connections. In some scenarios, IoT UEs can execute background applications (e.g., keep-alive messages, status updates, etc.) to facilitate the connections of the IoT network.

UEs 210 can communicate and establish a connection with one or more other UEs 210 via one or more wireless channels 212, each of which can comprise a physical communications interface/layer. The connection can include an M2M connection, MTC connection, D2D connection, SL connection, etc. The connection can involve a PC5 interface. In some implementations, UEs 210 can be configured to discover one another, negotiate wireless resources between one another, and establish connections between one another, without intervention or communications involving RAN node 222 or another type of network node. In some implementations, discovery, authentication, resource negotiation, registration, etc., can involve communications with RAN node 222 or another type of network node.

UEs 210 can use one or more wireless channels 212 to communicate with one another. As described herein, UE 210 can communicate with RAN node 222 to request SL resources. RAN node 222 can respond to the request by providing UE 210 with a dynamic grant (DG) or configured grant (CG) regarding SL resources. A DG can involve a grant based on a grant request from UE 210. A CG can involve a resource grant without a grant request and can be based on a type of service being provided (e.g., services that have strict timing or latency requirements). UE 210 can perform a clear channel assessment (CCA) procedure based on the DG or CG, select SL resources based on the CCA procedure and the DG or CG; and communicate with another UE 210 based on the SL resources. The UE 210 can communicate with RAN node 222 using a licensed frequency band and communicate with the other UE 210 using an unlicensed frequency band.

UEs 210 can communicate and establish a connection with (e.g., be communicatively coupled) with RAN 220, which can involve one or more wireless channels 214-1 and 214-2, each of which can comprise a physical communications interface/layer. In some implementations, a UE can be configured with dual connectivity (DC) as a multi-radio access technology (multi-RAT) or multi-radio dual connectivity (MR-DC), where a multiple receive and transmit (Rx/Tx) capable UE can use resources provided by different RAN network nodes (e.g., RAN network nodes 222-1 and 222-2) that can be connected via non-ideal backhaul (e.g., where one network node provides NR access and the other network node provides either E-UTRA for LTE or NR access for 5G). In such a scenario, one network node can operate as a master node (MN) and the other as the secondary node (SN). The MN and SN can be connected via a network interface, and at least the MN can be connected to the CN 230. Additionally, at least one of the MN or the SN can be operated with shared spectrum channel access, and functions specified for UE 210 can be used for an integrated access and backhaul mobile termination (IAB-MT). Similar for UE 210, the IAB-MT can access the network using either one network node or using two different nodes with enhanced dual connectivity (EN-DC) architectures, new radio dual connectivity (NR-DC) architectures, or the like. In some implementations, a base station (as described herein) can be an example of network RAN network nodes.

As shown, UE 210 can also, or alternatively, connect to access point (AP) 216 via connection interface 218, which can include an air interface enabling UE 210 to communicatively couple with AP 216. AP 216 can comprise a wireless local area network (WLAN), WLAN node, WLAN termination point, etc. The connection 218 can comprise a local wireless connection, such as a connection consistent with any IEEE 702.11 protocol, and AP 216 can comprise a wireless fidelity (Wi-Fi®) router or other AP. While not explicitly depicted in FIG. 2, AP 216 can be connected to another network (e.g., the Internet) without connecting to RAN 220 or CN 230. In some scenarios, UE 210, RAN 220, and AP 216 can be configured to utilize LTE-WLAN aggregation (LWA) techniques or LTE WLAN radio level integration with IPsec tunnel (LWIP) techniques. LWA can involve UE 210 in RRC_CONNECTED being configured by RAN 220 to utilize radio resources of LTE and WLAN. LWIP can involve UE 210 using WLAN radio resources (e.g., connection interface 218) via IPsec protocol tunneling to authenticate and encrypt packets (e.g., Internet Protocol (IP) packets) communicated via connection interface 218. IPsec tunneling can include encapsulating the entirety of original IP packets and adding a new packet header, thereby protecting the original header of the IP packets.

RAN 220 can include one or more RAN nodes 222-1 and 222-2 (referred to collectively as RAN nodes 222, and individually as RAN node 222) that enable channels 214-1 and 214-2 to be established between UEs 210 and RAN 220. A RAN node 222 can be a base station and may be referred to herein as base station 222. RAN nodes 222 can include network access points configured to provide radio baseband functions for data and/or voice connectivity between users and the network based on one or more of the communication technologies described herein (e.g., 2G, 3G, 4G, 5G, WiFi®, etc.). As examples therefore, a RAN node can be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 222 can include a roadside unit (RSU), a transmission reception point (TRxP or TRP), and one or more other types of ground stations (e.g., terrestrial access points). In some scenarios, RAN node 222 can be a dedicated physical device, such as a macrocell base station, and/or a low power (LP) base station for providing femtocells, picocells or the like having smaller coverage areas, smaller user capacity, or higher bandwidth compared to macrocells.

Some or all of RAN nodes 222, or portions thereof, can be implemented as one or more software entities running on server computers as part of a virtual network, which can be referred to as a centralized RAN (CRAN) and/or a virtual baseband unit pool (vBBUP). In these implementations, the CRAN or vBBUP can implement a RAN function split, such as a packet data convergence protocol (PDCP) split wherein radio resource control (RRC) and PDCP layers can be operated by the CRAN/vBBUP and other Layer 2 (L2) protocol entities can be operated by individual RAN nodes 222; a media access control (MAC)/physical (PHY) layer split wherein RRC, PDCP, radio link control (RLC), and MAC layers can be operated by the CRAN/vBBUP and the PHY layer can be operated by individual RAN nodes 222; or a “lower PHY” split wherein RRC, PDCP, RLC, MAC layers and upper portions of the PHY layer can be operated by the CRAN/vBBUP and lower portions of the PHY layer can be operated by individual RAN nodes 222. This virtualized framework can allow freed-up processor cores of RAN nodes 222 to perform or execute other virtualized applications.

In some implementations, an individual RAN node 222 can represent individual gNB-distributed units (DUs) connected to a gNB-control unit (CU) via individual F1 or other interfaces. In such implementations, the gNB-DUs can include one or more remote radio heads or radio frequency (RF) front end modules (RFEMs), and the gNB-CU can be operated by a server (not shown) located in RAN 220 or by a server pool (e.g., a group of servers configured to share resources) in a similar manner as the CRAN/vBBUP. Additionally, or alternatively, one or more of RAN nodes 222 can be next generation eNBs (i.e., gNBs) that can provide evolved universal terrestrial radio access (E-UTRA) user plane and control plane protocol terminations toward UEs 210, and that can be connected to a 5G core network (5GC) 230 via an NG interface.

Any of the RAN nodes 222 can terminate an air interface protocol and can be the first point of contact for UEs 210. In some implementations, any of the RAN nodes 222 can fulfill various logical functions for the RAN 220 including, but not limited to, radio network controller (RNC) functions such as radio bearer management, uplink and downlink dynamic radio resource management and data packet scheduling, and mobility management. UEs 210 can be configured to communicate using orthogonal frequency-division multiplexing (OFDM) communication signals with each other or with any of the RAN nodes 222 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals can comprise a plurality of orthogonal subcarriers.

In some implementations, a downlink resource grid can be used for downlink transmissions from any of the RAN nodes 222 to UEs 210, and uplink transmissions can utilize similar techniques. The grid can be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block can comprise a collection of resource elements (REs); in the frequency domain, this can represent the smallest quantity of resources that currently can be allocated. There are several different physical downlink channels that are conveyed using such resource blocks.

Further, RAN nodes 222 can be configured to wirelessly communicate with UEs 210, and/or one another, over a licensed medium (also referred to as the “licensed spectrum” and/or the “licensed band”), an unlicensed shared medium (also referred to as the “unlicensed spectrum” and/or the “unlicensed band”), or combination thereof. A licensed spectrum can correspond to channels or frequency bands selected, reserved, regulated, etc., for certain types of wireless activity (e.g., wireless telecommunication network activity), whereas an unlicensed spectrum can correspond to one or more frequency bands that are not restricted for certain types of wireless activity. Whether a particular frequency band corresponds to a licensed medium or an unlicensed medium can depend on one or more factors, such as frequency allocations determined by a public-sector organization (e.g., a government agency, regulatory body, etc.) or frequency allocations determined by a private-sector organization involved in developing wireless communication standards and protocols, etc.

The PDSCH can carry user data and higher layer signaling to UEs 210. The physical downlink control channel (PDCCH) can carry information about the transport format and resource allocations related to the PDSCH channel, among other things. The PDCCH can also inform UEs 210 about the transport format, resource allocation, and hybrid automatic repeat request (HARQ) information related to the uplink shared channel. Typically, downlink scheduling (e.g., assigning control and shared channel resource blocks to UE 210 within a cell) can be performed at any of the RAN nodes 222 based on channel quality information fed back from any of UEs 210. The downlink resource assignment information can be sent on the PDCCH used for (e.g., assigned to) each of UEs 210.

One or more of the techniques, described herein, can enable UE 210 to engage in adaptive PEI, including determining whether to disable or enable PEI monitoring, skip monitoring occasions, and determine whether to skip pre-syncing. For example, UE 210 can use various factors, such as intervals between occasions, power usage profiles, paging rate thresholds, SSB, paging, and PEI schedules or configurations, etc., to determine whether monitoring results in power savings. These and many other features and aspects of the techniques described herein are presented below with reference to remaining Figures.

The RAN nodes 222 can be configured to communicate with one another via interface 223. In implementations where the system is an LTE system, interface 223 can be an X2 interface. In NR systems, interface 223 can be an Xn interface. The X2 interface can be defined between two or more RAN nodes 222 (e.g., two or more eNBs/gNBs or a combination thereof) that connect to evolved packet core (EPC) or CN 230, or between two eNBs connecting to an EPC. The RAN nodes 222 can be configured to communicate with the CN 230 via various interfaces, such as physical interfaces, including interface 224, interface 226, and interface 228.

In some implementations, the X2 interface can include an X2 user plane interface (X2-U) and an X2 control plane interface (X2-C). The X2-U can provide flow control mechanisms for user data packets transferred over the X2 interface and can be used to communicate information about the delivery of user data between eNBs or gNBs. For example, the X2-U can provide specific sequence number information for user data transferred from a master eNB (MeNB) to a secondary eNB (SeNB); information about successful in sequence delivery of PDCP packet data units (PDUs) to a UE 210 from an SeNB for user data; information of PDCP PDUs that were not delivered to a UE 210; information about a current minimum desired buffer size at the SeNB for transmitting to the UE user data; and the like. The X2-C can provide intra-LTE access mobility functionality (e.g., including context transfers from source to target eNBs, user plane transport control, etc.), load management functionality, and inter-cell interference coordination functionality.

As shown, RAN 220 can be connected (e.g., communicatively coupled) to CN 230. CN 230 can comprise a plurality of network elements 232, which are configured to offer various data and telecommunications services to customers/subscribers (e.g., users of UEs 210) who are connected to the CN 230 via the RAN 220. In some implementations, CN 230 can include an evolved packet core (EPC), a 5G CN, and/or one or more additional or alternative types of CNs. The components of the CN 230 can be implemented in one physical node or separate physical nodes including components to read and execute instructions from a machine-readable or computer-readable medium (e.g., a non-transitory machine-readable storage medium). In some implementations, network function virtualization (NFV) can be utilized to virtualize any or all the above-described network node roles or functions via executable instructions stored in one or more computer-readable storage mediums (described in further detail below). A logical instantiation of the CN 230 can be referred to as a network slice, and a logical instantiation of a portion of the CN 230 can be referred to as a network sub-slice. Network Function Virtualization (NFV) architectures and infrastructures can be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more EPC components/functions.

As shown, CN 230, application servers 240, and external networks 250 can be connected to one another via interfaces 234, 236, and 238, which can include IP network interfaces. Application servers 240 can include one or more server devices or network elements (e.g., virtual network functions (VNFs) offering applications that use IP bearer resources with CN 230 (e.g., universal mobile telecommunications system packet services (UMTS PS) domain, LTE PS data services, etc.). Application servers 240 can also, or alternatively, be configured to support one or more communication services (e.g., voice over IP (VOIP) sessions, push-to-talk (PTT) sessions, group communication sessions, social networking services, etc.) for UEs 210 via the CN 230. Similarly, external networks 250 can include one or more of a variety of networks, including the Internet, thereby providing the mobile communication network and UEs 210 of the network access to a variety of additional services, information, interconnectivity, and other network features.

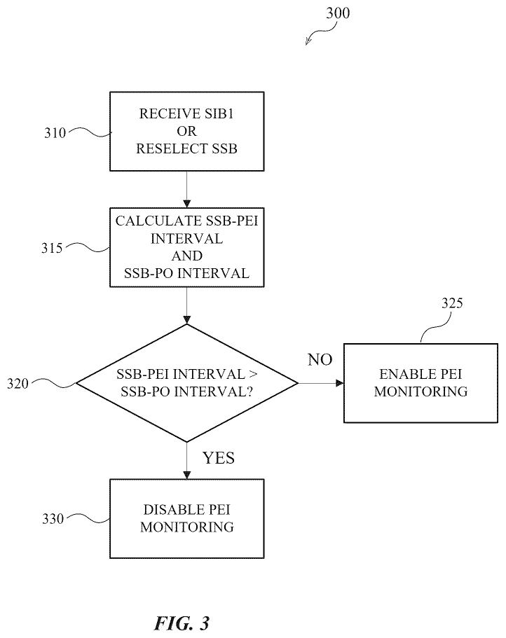

FIG. 3 is a diagram of an example of process 300 for adaptive PEI according to one or more implementations described herein. Process 300 can be implemented by UE 210. In some implementations, some or all of process 300 can be performed by one or more other systems or devices, including one or more of the devices of FIG. 2. Additionally, process 300 can include one or more fewer, additional, differently ordered and/or arranged operations than those shown in FIG. 3. In some implementations, some or all of the operations of process 300 can be performed independently, successively, simultaneously, etc., of one or more of the other operations of process 300. As such, the techniques described herein are not limited to a number, sequence, arrangement, timing, etc., of the operations or processes depicted in FIG. 3.

As shown, process 300 can include enabling or disabling PEI monitoring. PEI monitoring, as referred to herein, can include receiving and decoding PEI occasions, such as to determine whether PEI occasions include a PEI. In some examples, UE 210 can disable PEI monitoring when the network configuration is improper. Process 300 can include receiving or reselecting an SSB (block 310). For example, UE 210 can receive system information block 1 (SIB1) from base station 222. Alternatively, UE can reselect an SSB from base station 222. Reselecting a SSB can include selecting one of multiple SSBs transmitted by base station 222. In some examples, UE 210 can receive an SSB with different signal timing than a previously received SSB (block 310).

Process 300 can also include calculating an SSB-PEI interval and SSB-PO interval (at 315). For example, UE 210 can calculate or otherwise determine a power value according to a power model and a current configuration or schedule of SSBs, PEIs, and POs. A power model can include power use related to various states that correspond to signaling at UE 210. To calculate the power value, UE 210 can calculate or determine the interval, or time, between the SSB and PEI occasion (SSB-PEI interval) and the interval, or time, between the SSB and the paging occasion (SSB-PO interval).

Process 300 can include evaluating the SSB-PEI interval relative to the SSB-PO interval (block 320). For example, UE 210 can determine whether the SSB-PEI interval is greater than the SSB-PO interval. When the SSB-PEI interval is greater than the SSB-PO interval (block 320—YES), process 300 can include disabling PEI monitoring (block 330). For example, UE 210 can disable PEI monitoring in response to determining that monitoring PEI involves too much power relative to monitoring for PO instead.

When the SSB-PEI interval is less than the SSB-PO interval, process 300 can include disabling PEI monitoring (block 325). For example, UE 210 can enable PEI monitoring in response to determining that the power involved in monitoring PEI is warranted. A larger SSB-PEI interval can indicate that the power value does not result in power savings for UE 210, and enabling PEI would result in power loss. A larger SSB-PO interval can indicate that the power value results in power savings if PEI monitoring is enabled. While not shown, process 300 can include UE 210 reselecting the SSB (block 310). Reselection can result in changes to the SSB-PEI interval, the SSB-PO interval, or both, which can affect the power value and power savings. Thus, UE 210 can determine whether to enable PEI or disable PEI after reselecting the SSB.

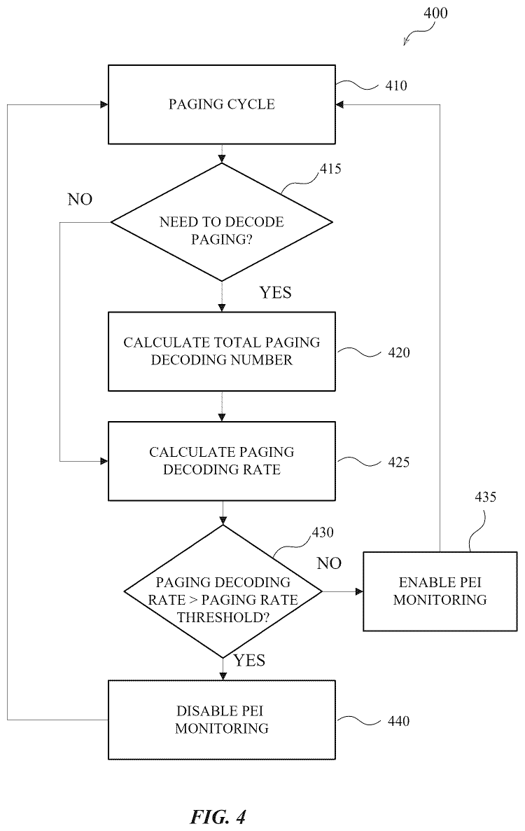

FIG. 4 is a diagram of an example of process 400 for adaptive PEI according to one or more implementations described herein. Process 400 can be implemented by UE 210. In some implementations, some or all of process 400 can be performed by one or more other systems or devices, including one or more of the devices of FIG. 2. Additionally, process 400 can include one or more fewer, additional, differently ordered and/or arranged operations than those shown in FIG. 4. In some implementations, some or all of the operations of process 400 can be performed independently, successively, simultaneously, etc., of one or more of the other operations of process 400. As such, the techniques described herein are not limited to a number, sequence, arrangement, timing, etc., of the operations or processes depicted in FIG. 4.

As described below, UE 210 can determine whether to enable or disable PEI monitoring based on paging rate factors, such as a paging rate threshold, total paging decoding number, and paging decoding rate. The paging rate threshold (T) can indicate a paging decoding rate at which UE 210 could save power by enabling PEI. The paging rate threshold can be determined according to a power model, paging configuration, and PEI configuration. A power model can include power use related to various states of UE 210 that correspond to signaling. For example, UE 210 can have a higher power use when decoding SSBs in an active state, and a lower power use when in an idle state between paging occasions and SSBs. Paging configuration and PEI configuration can include the timing or schedule of paging occasions, SSBs, and PEI occasions. In some examples, UE 210 can calculate the paging rate threshold prior to, during, or after the paging cycle. In some examples, UE 210 can identify or detect a paging configuration change and calculate a paging rate threshold based on a change in a paging configuration. A paging configuration can include time between paging occasions (e.g., a paging cycle).

Process 400 can include UE 210 participating in a paging cycle (at 410). The paging cycle can be the distance between each paging occasion and can include SSBs and PEI occasions. Process 400 can include UE 210 determining whether it is beneficial or necessary to decode a paging occasion (at 415). In response to determining to decode the paging occasions (at 415—YES) process 400 can include UE 210 calculating a total paging decoding number (at 420) and calculate the paging decoding rate (at 425). In response to determining to not to decode the paging occasion (at 415—NO) process 400 can include UE 210 refraining from calculating the total paging decoding number (at 420) and calculating the paging decoding rate (at 425).

Process 400 can include UE 210 can calculate the total paging decoding number according to the time window (at 420). The time window can include multiple paging cycles or multiple paging occasions. The total paging decoding number can be the number of paging occasions UE 210 decodes within the time window (or length of time). For example, there may be 4 scheduled paging occasions, but the network only indicates 3 paging signals to UE 210, so UE 210 only receives and decodes 3 of the 4 scheduled paging occasions. UE 210 can calculate the paging decoding rate by dividing the total decoded paging by the length of the paging cycle (at 425). The paging decoding rate can indicate how often UE 210 decodes paging occasions. For example, if the total paging decoding number is 3, and the length of the paging cycle is 40 ms, UE 210 can divide 3 by 40 ms to determine the paging decoding rate.

Process 400 can include UE 210 comparing the paging decoding rate to the paging rate threshold (at 430). When the paging decoding rate is not greater than the paging rate threshold, process 400 can include UE 210 enabling PEI monitoring (at 435). When the paging decoding rate is less than the paging rate threshold, enabling PEI monitoring can result in power savings for UE 210. After enabling PEI monitoring (at 435) process 400 can include UE 210 executing subsequent paging cycles according to the enabled PEI monitoring setting (at 410). When the paging decoding rate is greater than the paging rate threshold, process 400 can include UE 210 disabling PEI monitoring (at 440). When the paging decoding rate is greater than the paging rate threshold, PEI monitoring can result in power loss at UE 210. After disabling PEI monitoring, process 400 can include UE 210 engaging with subsequent paging cycles according to the disabled PEI monitoring setting (at 410).

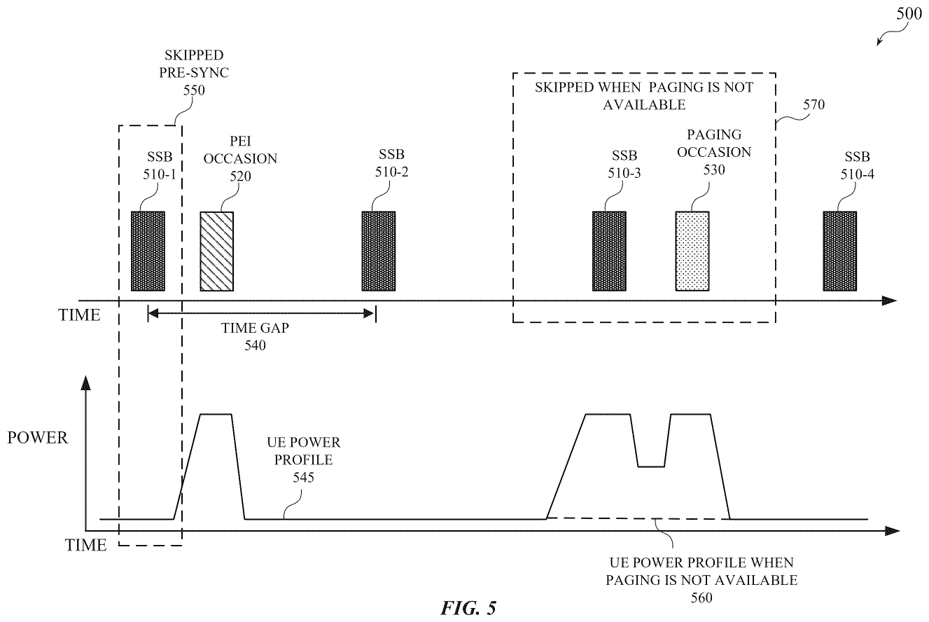

FIG. 5 is a diagram of an example 500 for adaptive PEI according to one or more implementations described herein. Example 500 depicts PEI-based adaptive pre-sync reduction. For example, UE 210 can skip or refrain from decoding SSB 510-1, as shown by skipped pre-sync 550, which can result in UE power savings. SSBs 510 can be separated by an interval, or time gap 540. UE power profile 545 describes power consumption of UE 210 when UE 210 skips SSB 510-1, shown by skipped pre-sync 550. In some examples, UE 210 can skip or refrain from decoding SSB 510-3, such as when paging is not available at paging occasion 530 (at 570) which can result further UE power savings. Reduction of UE power use is shown by UE power profile when paging is not available 560.

Reducing pre-syncing can be applicable to physical downlink control channel (PDCCH) PEI decoding, which can be more robust to frequency and timing errors than PDSCH paging and may not require pre-syncing for every paging occasion. Thus, skipping or refraining from decoding SSB 510-1, resulting in skipped pre-sync 550, may not result in reduced UE performance for decoding the PEI occasion 520. When PEI occasion 520 indicates to UE 210 to monitor for paging occasion 530, UE 210 can execute pre-sync by decoding SSB 510-3 prior to receiving paging occasion 530.

In some examples, such as when UE 210 skips pre-sync 550, UE 210 can execute pre-sync SSB 510-3 before paging occasion 530 when there is a PEI decoding failure or a PEI decoding pass that indicates a paging reception. A PEI decoding failure can happen when energy of the DCI is lower than a threshold. In examples, such as when there is not paging available at paging occasion 530, UE 210 can skip decoding SSB 510-3 and paging occasion 530 (at 570).

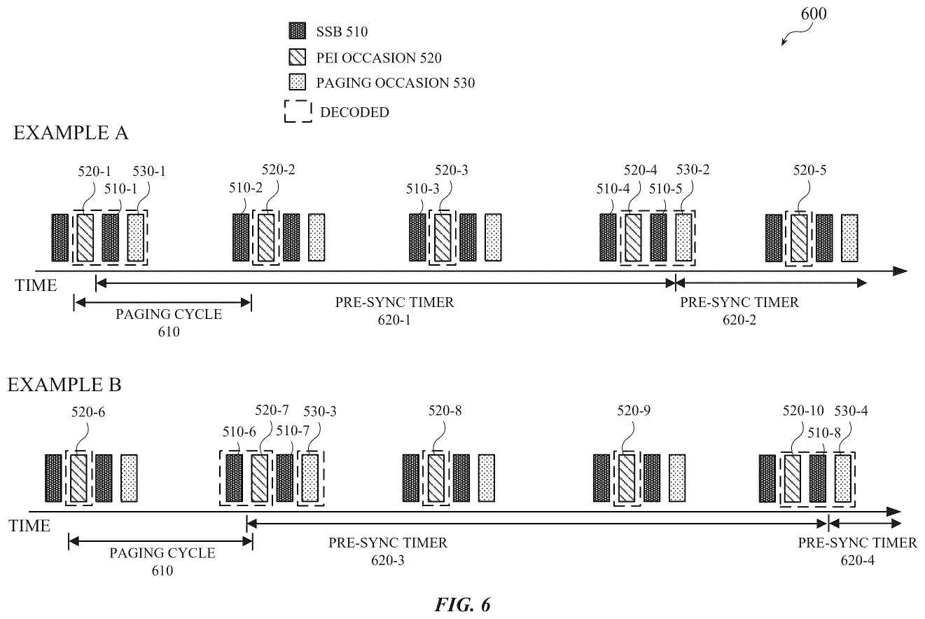

FIG. 6 is a diagram of an example 600 for adaptive PEI according to one or more implementations described herein. Example 600 describes PEI-based adaptive pre-sync reduction based on a pre-sync trigger. When executing a pre-sync, or decoding of SSB 510, UE 210 can start or restart a pre-sync timer 620. Decoding SSB 510 can include monitoring for and decoding SSB 510, decoding PEI occasion 520 can include monitoring for PEI occasion 520 and decoding the associated received signal and message, and decoding paging occasion 530 can include monitoring for paging occasion 530 and decoding the associated received signal and message. In some examples, such as the case of a low paging rate, pre-syncing occasionally can be necessary for UE 210 accuracy. The length of the pre-sync paging occasion timer 620 and pre-sync PEI timer 630 can be larger for PDCCH decoding.

As described with reference to Example A, UE 210 can decode PEI occasion 520-1 and start pre-sync timer 620-1. UE 210 can then decode SSB 510-1 and paging occasion 530-1. In some examples, UE 210 can start pre-sync timer 620-1 prior to decoding PEI occasion 520-1. While the pre-sync timer 620-1 is active, and has not expired, UE 210 can skip pre-syncing prior to the PEI occasions 520. For example, UE 210 can skip (e.g., refrain from decoding) SSB 510-2 prior to PEI occasion 520 and skip SSB 510-3 prior to paging occasion 530.

As shown in Example A, UE 210 can, for each paging cycle 610 and after skipping the pre-sync SSB 510 prior to PEI occasion 520, determine whether there has been a PEI decoding fail, or if there has been a PEI decode pass and paging is available. When neither of these conditions are met, and the pre-sync timer 620 has not expired, UE 210 skips pre-syncing, or decoding the SSB, prior to PEI occasion 520. For example, UE 210 can skip pre-sync SSB 510-2, and attempt to decode PEI occasion 520-2. UE 210 can determine that PEI decoding of PEI occasion 520-2 did not fail, the PEI decoding passed, but there is not paging available. UE 210 can skip SSB 510-3 and attempt to decode the subsequent PEI occasion 520-3. UE 210 can determine that PEI decoding of PEI occasion 520-3 did not fail, the PEI decoding passed, but there is not paging available.

In some examples, when UE 210 determines there was PEI decoding fail or PEI decoding passed and there is paging available, UE 210 determines if there is SSB 510 prior to paging occasion 530. When there is an SSB 510 prior to paging occasion 530, UE 210 can decode SSB 510 and restart pre-sync timer 620, and decoding paging occasion 530. In some examples, UE 210 can restart pre-sync time 620 prior to SSB 510. As show in Example A, UE 210 can skip SSB 510-4, and attempt to decode PEI occasion 520-4. UE 210 can determine that either PEI decoding failed or PEI decoding passed and paging is available at paging occasion 530-2. UE 210 can determine that SSB 510-5 exists prior to paging occasion 530-2. UE 210 can perform a pre-sync by decoding PEI occasion 520-4 and restart pre-sync timer 620-2. UE 210 can decode paging occasion 530-2.

In some examples, pre-sync time 620 can be expired. In such examples, UE 210 can perform a pre-sync prior to PEI occasion 520 by decoding the SSB 510 that occurs prior to the PEI occasion 520 and starting (e.g., restarting) pre-sync timer 620-3. In some examples, UE 210 can decode paging occasion 530 within the same paging cycle 610 as the pre-sync. In some examples, UE 210 can skip pre-syncing prior to paging occasion 530, or skip decoding SSB 510. As shown with reference to Example B, UE 210 can determine the pre-sync timer 620 is expired, such as at PEI occasion 520-6. UE 210 can, at the next paging cycle, perform pre-syncing prior to the PEI occasion 520 by decoding SSB 510-6 that occurs prior to PEI occasion 520-7. In some examples, UE 210 can skip decoding SSB 510-7, or refrain from pre-syncing prior to paging occasion 530-3. UE 210 can decode paging occasion 530-3.

In some examples, UE 210 can start pre-sync timer 620-3 after decoding SSB 510-6. In some examples, UE 210-can start pre-sync timer 620-3 after PEI occasion 520-7. In example B, similarly to Example A, UE 210 can, during the duration of pre-sync timer 620-3, skip pre-syncing prior to PEI occasions 520-8 and PEI occasion 520-9. UE 210 can, based on PEI decoding fail of PEI occasion 520-10 or PEI decoding pass of PEI occasion 520-10 when paging is available at paging occasion 530-4, determine that SSB 510-8 exists, or occurs, prior to paging occasion 530-4. UE 210 can decode SSB 510-8, or perform a pre-sync, restart pre-sync timer 620-4, and decode paging occasion 530-4.

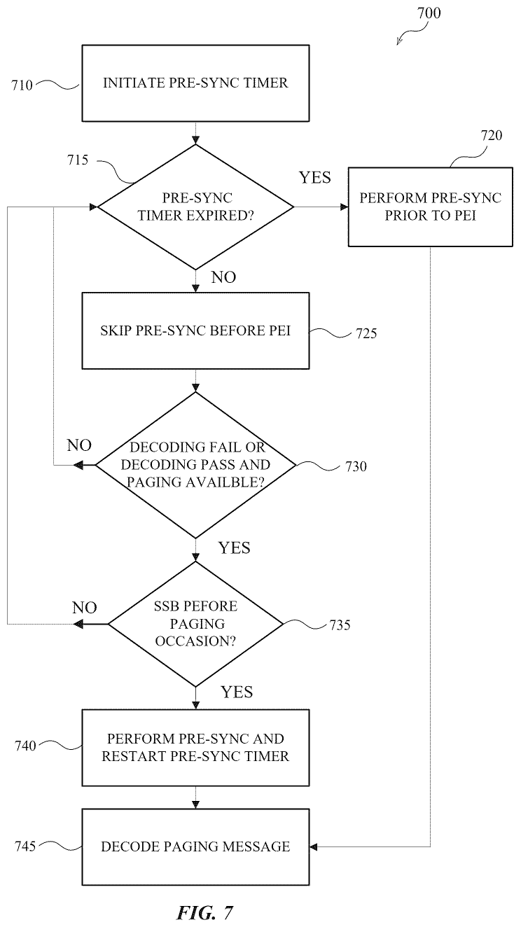

FIG. 7 is a diagram of an example process 700 for adaptive PEI according to one or more implementations described herein. Process 700 can be implemented by UE 210. In some implementations, some or all of process 700 can be performed by one or more other systems or devices, including one or more of the devices of FIG. 2. Additionally, process 700 can include one or more fewer, additional, differently ordered and/or arranged operations than those shown in FIG. 7. In some implementations, some or all of the operations of process 700 can be performed independently, successively, simultaneously, etc., of one or more of the other operations of process 700. As such, the techniques described herein are not limited to a number, sequence, arrangement, timing, etc., of the operations or processes depicted in FIG. 7. FIG. 7 can be an example of PEI-based adaptive pre-sync reduction as described above with reference to FIG. 6.

Process 700 can include UE 210 initiating a pre-sync timer (at 710). For example, UE 210 can identify or detect when the pre-sync timer has expired (at 715). Process 700 can include UE 210 determining whether the pre-sync timer has expired (at 715). When the pre-sync timer has expired (at 715—YES) process 700 can include UE 210 performing a pre-sync before a PEI (at 720) and in accordance with the PEI, decoding a subsequent paging message (at 745). For example, the pre-sync may include decoding an SSB that occurs prior to the next occurring PEI occasion. In some examples, UE 210 can restart the pre-sync timer before or after performing the pre-sync, before or after the PEI occasion, before or after decoding a PEI signal corresponding to the PEI occasion, or before or after decoding the paging message (at 720). In some examples, UE 210 can decode the PEI signal (e.g., message) of the PEI occasion after the SSB and prior to decoding the paging message (at 745). In some examples, UE 210 can refrain from, or skip, monitoring and decoding the pre-sync, or SSB, the occurs after the PEI occasions and prior to the paging occasion.

When the pre-sync timer has not expired (at 715—NO) process 700 can include UE 210 skipping (e.g., refraining from) monitoring for, decoding, or both, the pre-syncing before the PEI occasion (at 725). Pre-syncing can include decoding an SSB that occurs prior to the PEI occasion (at 725). Process 700 can include UE 210 determining whether there was a PEI decoding failure or whether there was a PEI decoding pass and a paging occasion is available (at 730). In some examples, process 700 can include UE 210 decoding the PEI signal (e.g., message) associated with the PEI paging occasion occurring after the pre-sync.

When there was not a decoding failure or decoding pass with an available paging occasion (at 730—NO), process 700 can include UE 210 determining whether the pre-sync timer has expired (at 715). When there was a decoding failure or decoding pass with an available paging occasion (at 730—YES), process 700 can include UE 210 determining whether an SSB exists prior to the paging occasion (at 735). When an SSB does not occur prior to the paging occasion (at 735—NO), pre-sync prior to the paging occasion can be possible and process 700 can include UE 210 checking whether the pre-sync timer has expired (at 715). When an SSB does exist prior to the paging occasion (block 735—YES), process 700 can include UE 210 performing the pre-sync (e.g., to decode a subsequent SSB that occurs after the PEI occasion and prior to the paging occasion) and reinitiating the pre-sync timer (at 740). Process 700 can include UE 210 decoding the paging message after performing the pre-sync and restarting the pre-sync timer (at 745).

Reducing pre-syncs can result in power savings, as shown in the following Table 4. Table 4 describes power saving based on various paging rates and whether PEI is enabled with or without pre-sync reduction.

TABLE 4

| | | Power for PEI | |
|---|---|---|---|
| | Power for PEI | Enabled with | |
| Paging | Enabled with | Pre-Sync | Power |
| Rate | Pre-Sync | reduction | Saving |
| 640 | 1.5606 | 1.3052 | 16.37% |
| 1280 | 1.0394 | 0.8965 | 13.75% |
| 2569 | 0.7197 | 0.6482 | 9.93% |
| 5120 | 0.6052 | 0.5695 | 5.90% |
| 10240 | 0.5480 | 0.5302 | 3.25% |

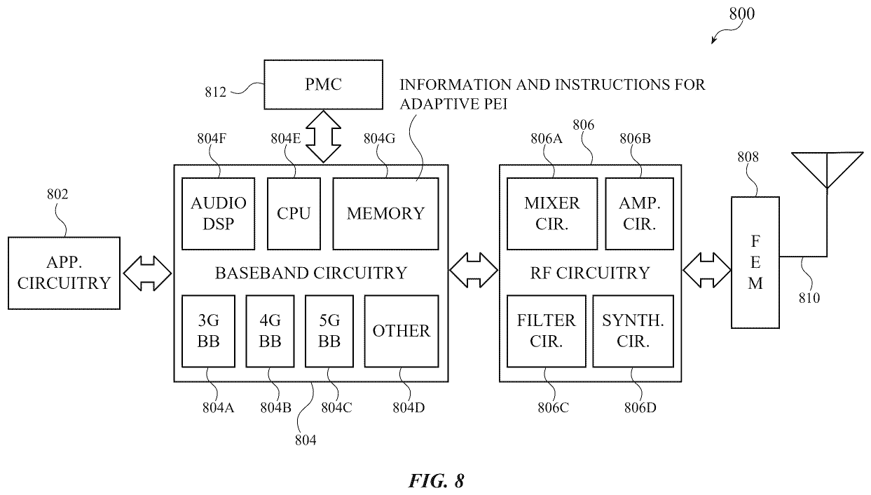

FIG. 8 is a diagram of an example of components of a device according to one or more implementations described herein. In some implementations, the device 800 can include application circuitry 802, baseband circuitry 804, RF circuitry 806, front-end module (FEM) circuitry 808, one or more antennas 810, and power management circuitry (PMC) 812 coupled together at least as shown. The components of the illustrated device 800 can be included in a UE or a RAN node. In some implementations, the device 800 can include fewer elements (e.g., a RAN node may not utilize application circuitry 802, and instead include a processor/controller to process IP data received from a CN or an Evolved Packet Core (EPC)). In some implementations, the device 800 can include additional elements such as, for example, memory/storage, display, camera, sensor (including one or more temperature sensors, such as a single temperature sensor, a plurality of temperature sensors at different locations in device 800, etc.), or input/output (I/O) interface. In other implementations, the components described below can be included in more than one device (e.g., said circuitries can be separately included in more than one device for Cloud-RAN (C-RAN) implementations).

The application circuitry 802 can include one or more application processors. For example, the application circuitry 802 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 800. In some implementations, processors of application circuitry 802 can process IP data packets received from an EPC.

The baseband circuitry 804 can include circuitry such as, but not limited to, one or more single-core or multi-core processors. The baseband circuitry 804 can include one or more baseband processors or control logic to process baseband signals received from a receive signal path of the RF circuitry 806 and to generate baseband signals for a transmit signal path of the RF circuitry 806. Baseband circuitry 804 can interface with the application circuitry 802 for generation and processing of the baseband signals and for controlling operations of the RF circuitry 806. For example, in some implementations, the baseband circuitry 804 can include a 3G baseband processor 804A, a 4G baseband processor 804B, a 5G baseband processor 804C, or other baseband processor(s) 804D for other existing generations, generations in development or to be developed in the future (e.g., 5G, 6G, etc.). The baseband circuitry 804 (e.g., one or more of baseband processors 804A-D) can handle various radio control functions that enable communication with one or more radio networks via the RF circuitry 806. In other implementations, some or all of the functionality of baseband processors 804A-D can be included in modules stored in the memory 804G and executed via a Central Processing Unit (CPU) 804E. The radio control functions can include, but are not limited to, signal modulation/demodulation, encoding/decoding, radio frequency shifting, etc. In some implementations, modulation/demodulation circuitry of the baseband circuitry 804 can include Fast-Fourier Transform (FFT), precoding, or constellation mapping/de-mapping functionality. In some implementations, encoding/decoding circuitry of the baseband circuitry 804 can include convolution, tail-biting convolution, turbo, Viterbi, or Low-Density Parity Check (LDPC) encoder/decoder functionality. Implementations of modulation/demodulation and encoder/decoder functionality are not limited to these examples and can include other suitable functionality in other implementations.

In some implementations, memory 804G can receive and/or store information and instructions for enabling UE 210, and/or one or more components thereof, to engage in adaptive PEI. For example, the information and instructions can cause and/or enable UE 210 to determine whether the network configuration and power model for communications is power efficient. If UE 210 determines the network configuration is power efficient, UE 210 can enable PEI monitoring. Otherwise, UE 210 can disable PEI monitoring. In some examples, UE 210 can determine whether to enable or disable PEI monitoring based on the selected SSB or paging rate. In some examples, the information and instructions can cause and/or enable UE 210 to perform PEI-based adaptive pre-sync reduction by skipping pre-syncs.

In some implementations, the baseband circuitry 804 can include one or more audio digital signal processor(s) (DSP) 804F. The audio DSPs 804F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of the baseband circuitry 804 and the application circuitry 802 can be implemented together such as, for example, on a system on a chip (SOC).

In some implementations, the baseband circuitry 804 can provide for communication compatible with one or more radio technologies. For example, in some implementations, the baseband circuitry 804 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 804 is configured to support radio communications of more than one wireless protocol can be referred to as multi-mode baseband circuitry.

RF circuitry 806 can enable communication with wireless networks using modulated electromagnetic radiation through a non-solid medium. In various implementations, the RF circuitry 806 can include switches, filters, amplifiers, etc. to facilitate the communication with the wireless network. RF circuitry 806 can include a receive signal path which can include circuitry to down-convert RF signals received from the FEM circuitry 808 and provide baseband signals to the baseband circuitry 804. RF circuitry 806 can also include a transmit signal path which can include circuitry to up-convert baseband signals provided by the baseband circuitry 804 and provide RF output signals to the FEM circuitry 808 for transmission.

In some implementations, the receive signal path of the RF circuitry 806 can include mixer circuitry 806A, amplifier circuitry 806B and filter circuitry 806C. In some implementations, the transmit signal path of the RF circuitry 806 can include filter circuitry 806C and mixer circuitry 806A. RF circuitry 806 can also include synthesizer circuitry 806D for synthesizing a frequency for use by the mixer circuitry 806A of the receive signal path and the transmit signal path. In some implementations, the mixer circuitry 806A of the receive signal path can be configured to down-convert RF signals received from the FEM circuitry 808 based on the synthesized frequency provided by synthesizer circuitry 806D. The amplifier circuitry 806B can be configured to amplify the down-converted signals and the filter circuitry 806C can be a low-pass filter (LPF) or band-pass filter (BPF) configured to remove unwanted signals from the down-converted signals to generate output baseband signals. Output baseband signals can be provided to the baseband circuitry 804 for further processing. In some implementations, the output baseband signals can be zero-frequency baseband signals, although this is not a requirement. In some implementations, mixer circuitry 806A of the receive signal path can comprise passive mixers, although the scope of the implementations is not limited in this respect.

In some implementations, the mixer circuitry 806A of the transmit signal path can be configured to up-convert input baseband signals based on the synthesized frequency provided by the synthesizer circuitry 806D to generate RF output signals for the FEM circuitry 808. The baseband signals can be provided by the baseband circuitry 804 and can be filtered by filter circuitry 806C.

In some implementations, the mixer circuitry 806A of the receive signal path and the mixer circuitry 806A of the transmit signal path can include two or more mixers and can be arranged for quadrature down conversion and up conversion, respectively. In some implementations, the mixer circuitry 806A of the receive signal path and the mixer circuitry 806A of the transmit signal path can include two or more mixers and can be arranged for image rejection (e.g., Hartley image rejection). In some implementations, the mixer circuitry 806A of the receive signal path and the mixer circuitry 806A can be arranged for direct down conversion and direct up conversion, respectively. In some implementations, the mixer circuitry 806A of the receive signal path and the mixer circuitry 806A of the transmit signal path can be configured for super-heterodyne operation.

In some implementations, the output baseband signals, and the input baseband signals can be analog baseband signals, although the scope of the implementations is not limited in this respect. In some alternate implementations, the output baseband signals, and the input baseband signals can be digital baseband signals. In these alternate implementations, the RF circuitry 806 can include analog-to-digital converter (ADC) and digital-to-analog converter (DAC) circuitry and the baseband circuitry 804 can include a digital baseband interface to communicate with the RF circuitry 806.

In some dual-mode implementations, a separate radio IC circuitry can be provided for processing signals for each spectrum, although the scope of the implementations is not limited in this respect.

In some implementations, the synthesizer circuitry 806D can be a fractional-N synthesizer or a fractional N/N+1 synthesizer, although the scope of the implementations is not limited in this respect as other types of frequency synthesizers can be suitable. For example, synthesizer circuitry 806D can be a delta-sigma synthesizer, a frequency multiplier, or a synthesizer comprising a phase-locked loop with a frequency divider.

The synthesizer circuitry 806D can be configured to synthesize an output frequency for use by the mixer circuitry 806A of the RF circuitry 806 based on a frequency input and a divider control input. In some implementations, the synthesizer circuitry 806D can be a fractional N/N+1 synthesizer.

In some implementations, frequency input can be provided by a voltage-controlled oscillator (VCO), although that is not a requirement. Divider control input can be provided by either the baseband circuitry 804 or the applications circuitry 802 depending on the desired output frequency. In some implementations, a divider control input (e.g., N) can be determined from a look-up table based on a channel indicated by the applications circuitry 802.

Synthesizer circuitry 806D of the RF circuitry 806 can include a divider, a delay-locked loop (DLL), a multiplexer and a phase accumulator. In some implementations, the divider can be a dual modulus divider (DMD) and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 806D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, the RF circuitry 806 can include an IQ/polar converter.

FEM circuitry 808 can include a receive signal path which can include circuitry configured to operate on RF signals received from one or more antennas 810, amplify the received signals and provide the amplified versions of the received signals to the RF circuitry 806 for further processing. FEM circuitry 808 can also include a transmit signal path which can include circuitry configured to amplify signals for transmission provided by the RF circuitry 806 for transmission by one or more of the one or more antennas 810. In various implementations, the amplification through the transmit or receive signal paths can be done solely in the RF circuitry 806, solely in the FEM circuitry 808, or in both the RF circuitry 806 and the FEM circuitry 808.

In some implementations, the FEM circuitry 808 can include a TX/RX switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 806). The transmit signal path of the FEM circuitry 808 can include a power amplifier (PA) to amplify input RF signals (e.g., provided by RF circuitry 806), and one or more filters to generate RF signals for subsequent transmission (e.g., by one or more of the one or more antennas 810).

In some implementations, the PMC 812 can manage power provided to the baseband circuitry 804. In particular, the PMC 812 can control power-source selection, voltage scaling, battery charging, or DC-to-DC conversion. The PMC 812 can often be included when the device 800 is capable of being powered by a battery, for example, when the device is included in a UE. The PMC 812 can increase the power conversion efficiency while providing desirable implementation size and heat dissipation characteristics.

While FIG. 8 shows the PMC 812 coupled only with the baseband circuitry 804. However, in other implementations, the PMC 812 can be additionally or alternatively coupled with, and perform similar power management operations for, other components such as, but not limited to, application circuitry 802, RF circuitry 806, or FEM circuitry 808.

In some implementations, the PMC 812 can control, or otherwise be part of, various power saving mechanisms of the device 800. For example, if the device 800 is in an RRC_Connected state, where it is still connected to the RAN node as it expects to receive traffic shortly, then it can enter a state known as Discontinuous Reception Mode (DRX) after a period of inactivity. During this state, the device 800 can power down for brief intervals of time and thus save power.

If there is no data traffic activity for an extended period of time, then the device 800 can transition off to an RRC_Idle state, where it disconnects from the network and does not perform operations such as channel quality feedback, handover, etc. The device 800 goes into a very low power state and it performs paging where again it periodically wakes up to listen to the network and then powers down again. The device 800 may not receive data in this state; in order to receive data, it can transition back to RRC_Connected state.

An additional power saving mode can allow a device to be unavailable to the network for periods longer than a paging interval (ranging from seconds to a few hours). During this time, the device is unreachable to the network and can power down completely. Any data sent during this time incurs a large delay and it is assumed the delay is acceptable.

Processors of the application circuitry 802 and processors of the baseband circuitry 804 can be used to execute elements of one or more instances of a protocol stack. For example, processors of the baseband circuitry 804, alone or in combination, can be used execute Layer 3, Layer 2, or Layer 1 functionality, while processors of the baseband circuitry 804 can utilize data (e.g., packet data) received from these layers and further execute Layer 4 functionality (e.g., transmission communication protocol (TCP) and user datagram protocol (UDP) layers). As referred to herein, Layer 3 can comprise a RRC layer, described in further detail below. As referred to herein, Layer 2 can comprise a medium access control (MAC) layer, a radio link control (RLC) layer, and a packet data convergence protocol (PDCP) layer, described in further detail below. As referred to herein, Layer 1 can comprise a physical (PHY) layer of a UE/RAN node, described in further detail below.

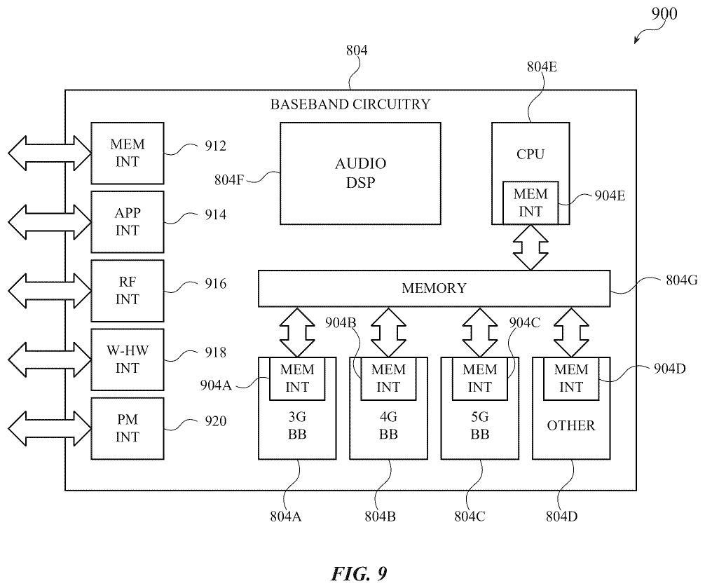

FIG. 9 is a diagram of example interfaces 900 of baseband circuitry according to one or more implementations described herein. As discussed above, the baseband circuitry 804 of FIG. 8 can comprise processors 804A through 804E and a memory 804G utilized by said processors. Each of the processors 804A through 804E can include a memory interface, 940A through 940E, respectively, to send/receive data to/from the memory 804G.

In some implementations, memory 804G can receive, store, and/or provide information and instructions for RIS selection. For example, base station 222 can communicate RIS selection information to UE 210, and UE 210 can select one or more RISs 260 based on the RIS selection information and/or additional criteria. UE 210 can indicate the selected RISs 260 to base station 222, and base station 222 can select one or more RISs 260. Base station 222 can also, or alternatively, configure one or more RISs 260 for communications between base station 222 and UE 210. The information and instructions can also cause or enable UE 210, base station 222, and/or RIS 260 to perform one or more additional, alternative, or different operations described herein.

The baseband circuitry 804 can further include one or more interfaces to communicatively couple to other circuitries/devices, such as a memory interface 852 (e.g., an interface to send/receive data to/from memory external to the baseband circuitry 804), an application circuitry interface 954 (e.g., an interface to send/receive data to/from the application circuitry 802 of FIG. 8), an RF circuitry interface 956 (e.g., an interface to send/receive data to/from RF circuitry 806 of FIG. 8), a wireless hardware connectivity interface 958 (e.g., an interface to send/receive data to/from Near Field Communication (NFC) components, Bluetooth® components (e.g., Bluetooth® Low Energy), Wi-Fi® components, and other communication components), and a power management interface 960 (e.g., an interface to send/receive power or control signals to/from the PMC 812).

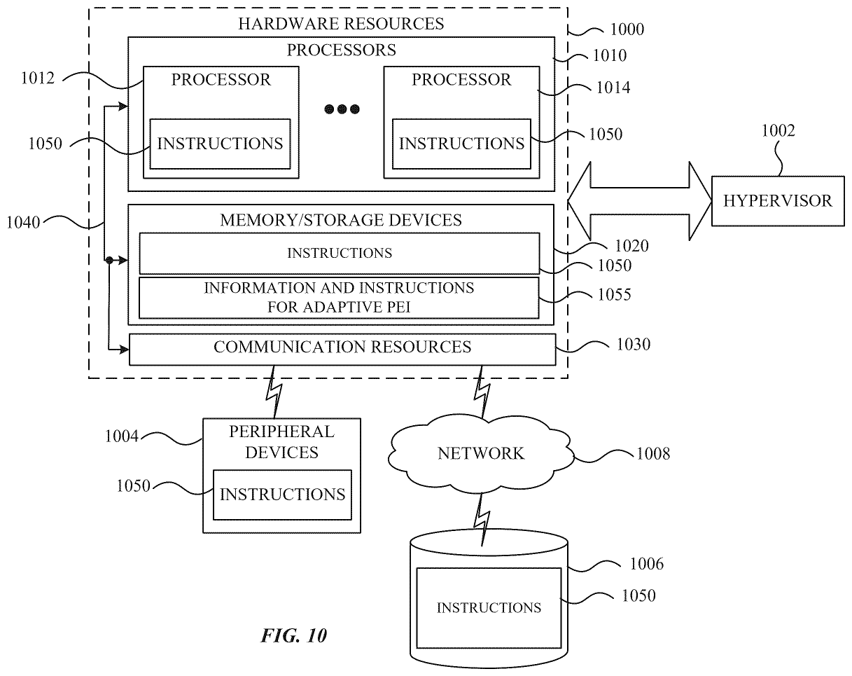

FIG. 10 is a block diagram illustrating components, according to some example implementations, able to read instructions from a machine-readable or computer-readable medium (e.g., a non-transitory machine-readable storage medium) and perform any one or more of the methodologies discussed herein. Specifically, FIG. 10 shows a diagrammatic representation of hardware resources 1000 including one or more processors (or processor cores) 1010, one or more memory/storage devices 1010, and one or more communication resources 1030, each of which can be communicatively coupled via a bus 1040. For implementations where node virtualization (e.g., NFV) is utilized, a hypervisor can be executed to provide an execution environment for one or more network slices/sub-slices to utilize the hardware resources 1000.

The processors 1010 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) can include, for example, a processor 1012 and a processor 1014.

The memory/storage devices 1010 can include main memory, disk storage, or any suitable combination thereof. The memory/storage devices 1010 can include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

In some implementations, memory/storage devices 1010 receive and/or store information and instructions 1055 for adaptive PEI. For example, UE 210 can receive, such as from a base station, SSBs, PEI messages, and paging messages. These and many other features and examples are discussed herein.

The communication resources 1030 can include interconnection or network interface components or other suitable devices to communicate with one or more peripheral devices 1004 or one or more databases 1006 via a network 1008. For example, the communication resources 1030 can include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1050 can comprise software, a program, an application, an applet, an app, or other executable code for causing at least any of the processors 1010 to perform any one or more of the methodologies discussed herein. The instructions 1050 can reside, completely or partially, within at least one of the processors 1010 (e.g., within the processor's cache memory), the memory/storage devices 1010, or any suitable combination thereof. Furthermore, any portion of the instructions 1050 can be transferred to the hardware resources 1000 from any combination of the peripheral devices 1004 or the databases 1006. Accordingly, the memory of processors 1010, the memory/storage devices 1010, the peripheral devices 1004, and the databases 1006 are examples of computer-readable and machine-readable media.

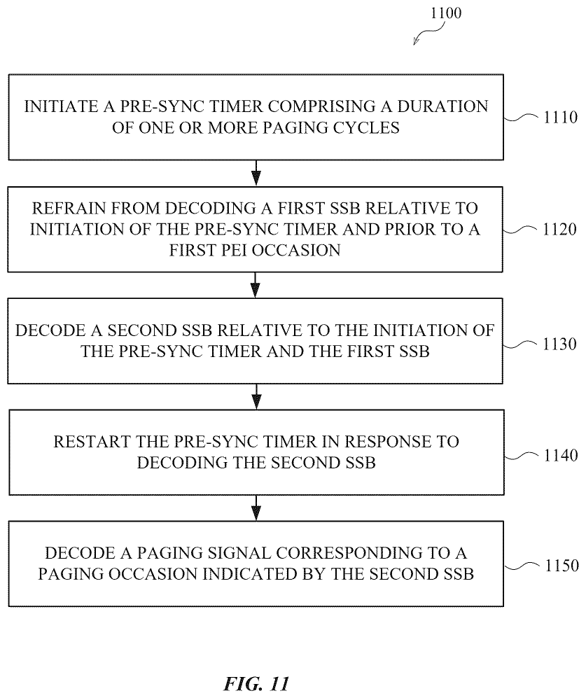

FIG. 11 is a diagram of an example process for adaptive PEI according to one or more implementations described herein. Process 1100 can be implemented by UE 210, baseband circuitry, or both. In some implementations, some or all of process 1100 can be performed by one or more other systems or devices, including one or more of the devices of FIG. 2. Additionally, process 1100 can include one or more fewer, additional, differently ordered and/or arranged operations than those shown in FIG. 11. In some implementations, some or all of the operations of process 1100 can be performed independently, successively, simultaneously, etc., of one or more of the other operations of process 1100. As such, the techniques described herein are not limited to a number, sequence, arrangement, timing, etc., of the operations or processes depicted in FIG. 11.

Process 1100 can include initiating a pre-sync timer comprising a duration of one or more paging cycles (block 1110). Process 1100 can include refraining decoding a first SSB relative to initiation of the pre-sync timer and prior to a first PEI occasion (block 1120). Process 1100 can include decoding a second SSB relative to the initiation of the pre-sync timer and the first SSB (block 1130). Process 1100 can include restarting the pre-sync timer in response to decoding the second SSB (block 1140). Process 1100 can include decoding a paging signal corresponding to a paging occasion indicated by the second SSB (block 1150).

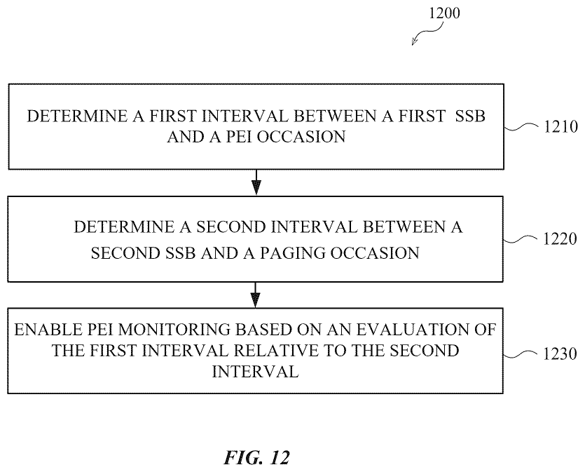

FIG. 12 is a diagram of an example process for adaptive PEI according to one or more implementations described herein. Process 1200 can be implemented by UE 210. In some implementations, some or all of process 1200 can be performed by one or more other systems or devices, including one or more of the devices of FIG. 2. Additionally, process 1200 can include one or more fewer, additional, differently ordered and/or arranged operations than those shown in FIG. 12. In some implementations, some or all of the operations of process 1200 can be performed independently, successively, simultaneously, etc., of one or more of the other operations of process 1200. As such, the techniques described herein are not limited to a number, sequence, arrangement, timing, etc., of the operations or processes depicted in FIG. 12.

Process 1200 can include determining a first interval between a first SSB and a PEI occasion (block 1210). Process 1200 can include determining a second interval between a second SSB and a paging occasion (block 1220). Process 1200 can include enabling PEI monitoring based on an evaluation of the first interval relative to the second interval (block 1230).

Examples and/or implementations herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which can also include one or more of the examples described herein, a UE (e.g., UE 210) can comprise: a memory; and one or more processors configured to, when executing instructions stored in the memory, cause UE 210 to: initiate a pre-sync timer comprising a duration of one or more paging cycles; refrain from decoding a first SSB relative to initiation of the pre-sync timer and prior to a first PEI occasion; decode a second SSB relative to the initiation of the pre-sync timer and the first SSB; restart the pre-sync timer in response to decoding the second SSB; and decode a paging signal corresponding to a paging occasion indicated by the second SSB, the paging occasion comprising a first paging occasion of a sequence of paging occasions indicated by the second SSB.

In example 2, which can also include one or more of the examples described herein, the one or more processors are further configured to cause UE 210 to: decode a PEI signal corresponding to the first PEI occasion.

In example 3, which can also include one or more of the examples described herein, refraining from decoding the first SSB is further based on the pre-sync timer not being expired.

In example 4, which can also include one or more of the examples described herein, decoding the paging signal is based on failure to decode a PEI signal associated with the first PEI occasion.

In example 5, which can also include one or more of the examples described herein, decoding the paging signal is based on refraining from decoding a PEI signal corresponding to the first PEI occasion and availability of the paging occasion.

In example 6, which can also include one or more of the examples described herein, decoding the second SSB is based on the second SSB occurring prior to the paging occasion.

In example 7, which can also include one or more of the examples described herein, restarting the pre-sync timer is based on the second SSB occurring prior to the paging occasion.

In example 8, which can also include one or more of the examples described herein, wherein a paging cycle of the one or more paging cycles comprises a time from an end of the first SSB to an end of the second SSB.

In example 9, which can also include one or more of the examples described herein, one or more processors are further configured to cause UE 210 to: detect expiration of the pre-sync timer; decode a third SSB based on expiration of the pre-sync timer and the third SSB occurring prior to the following PEI occasion; and decoding a second paging message.

In example 10, which can also include one or more of the examples described herein, UE 210 can comprise a memory; and one or more processors configured to, when executing instructions stored in the memory, cause UE 210 to: determine a first interval between a first SSB and a PEI occasion; determine a second interval between a second SSB and a paging occasion; and enable PEI monitoring based on an evaluation of the first interval relative to the second interval.

In example 11, which can also include one or more of the examples described herein, the evaluation of the first interval and the second interval comprises determining that the second interval is larger than the first interval.

In example 12, which can also include one or more of the examples described herein, determining the first interval and the second interval is based on receiving a system information block.

In example 13, which can also include one or more of the examples described herein, determining the first interval and the second interval is based on reselection of the first SSB.

In example 14, which can also include one or more of the examples described herein, the one or more processors are further executable to cause UE 210 to: determine a paging rate threshold based on a power model and PEI configuration; and determine a paging decoding rate based on a total paging decoding number and a time window, wherein enabling PEI monitoring is further based on an evaluation of the paging decode rate relative to the paging rate threshold.

In example 15, which can also include one or more of the examples described herein, the total paging decoding number comprises a number of decoded paging signals corresponding to respective paging occasions.

In example 16, which can also include one or more of the examples described herein, the time window comprises one of more paging cycles, a paging cycle of the one or more paging cycles comprising a time between paging occasions.

In example 17, which can also include one or more of the examples described herein, the one or more processors are further executable to cause UE 210 to: detect a change to a paging configuration; and determine the paging rate threshold based on the change to the paging configuration.

In example 18, which can also include one or more of the examples described herein, the one or more processors are further executable to cause UE 210 to: initiate a pre-sync timer comprising a duration of one or more paging cycles; and refrain from decoding the first SSB relative to initiation of the pre-sync timer and prior to the PEI occasion.

In example 19, which can also include one or more of the examples described herein, the one or more processors are further executable to cause UE 210 to: decode the second SSB relative to the initiation of the pre-sync timer and the first SSB; restart the pre-sync timer in response to decoding the second SSB; and decode a paging signal corresponding to a paging occasion indicated by the second SSB, the paging occasion comprising a first paging occasion of a sequence of paging occasions indicated by the second SSB.

In example 20, which can also include one or more of the examples described herein, base baseband circuitry can comprise a memory; and one or more processors configured to, when executing instructions stored in the memory, cause the baseband circuitry to: initiate a pre-sync timer comprising a duration for one or more paging cycles; refrain from decoding a first SSB relative to initiation of the pre-sync timer and prior to a first PEI occasion; decode a second SSB relative to the initiation of the pre-sync timer and the first SSB; restart the pre-sync timer in response to decoding the second SSB; and decode a paging signal corresponding to a paging occasion indicated by the second SSB, the paging occasion comprising a first paging occasion of a sequence of paging occasions indicated by the second SSB.

The examples discussed above also extend to method, computer-readable medium, and means-plus-function claims and implementations, any of which can include one or more of the features or operations of any one or combination of the examples mentioned above.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature can have been disclosed with respect to only one of several implementations, such feature can be combined with one or more other features of the other implementations as can be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context can indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

What is claimed is:

1. A user equipment (UE), comprising:
a memory; and
one or more processors configured to, when executing instructions stored in the memory, cause the UE to:
initiate a pre-sync timer comprising a duration of one or more paging cycles;
refrain from decoding a first synchronization signal block (SSB) relative to initiation of the pre-sync timer and prior to a first paging early indication (PEI) occasion;
decode a second SSB relative to the initiation of the pre-sync timer and the first SSB;
restart the pre-sync timer in response to decoding the second SSB; and
decode a paging signal corresponding to a paging occasion indicated by the second SSB.

2. The UE of claim 1, wherein the one or more processors are further configured to cause the UE to:
decode a PEI signal corresponding to the first PEI occasion.

3. The UE of claim 1, wherein refraining from decoding the first SSB is further based on the pre-sync timer not being expired.

4. The UE of claim 1, wherein decoding the paging signal is based on failure to decode a PEI signal associated with the first PEI occasion.

5. The UE of claim 1, wherein decoding the paging signal is based on refraining from decoding a PEI signal corresponding to the first PEI occasion and availability of the paging occasion.

6. The UE of claim 1, wherein decoding the second SSB is based on the second SSB occurring prior to the paging occasion, the paging occasion comprising a first paging occasion of a sequence of paging occasions indicated by the second SSB.

7. The UE of claim 1, wherein restarting the pre-sync timer is based on the second SSB occurring prior to the paging occasion.

8. The UE of claim 1, wherein a paging cycle of the one or more paging cycles comprises a time from an end of the first SSB to an end of the second SSB.

9. The UE of claim 1, wherein the one or more processors are further configured to cause the UE to:
detect expiration of the pre-sync timer;
decode a third SSB based on expiration of the pre-sync timer and the third SSB occurring prior to the following PEI occasion; and
decoding a second paging message.

10. A user equipment (UE), comprising:
a memory; and
one or more processors configured to, when executing instructions stored in the memory, cause the UE to:
determine a first interval between a first synchronization signal block (SSB) and a paging early indication (PEI) occasion;
determine a second interval between a second SSB and a paging occasion; and
enable PEI monitoring based on an evaluation of the first interval relative to the second interval.

11. The UE of claim 10, wherein the evaluation of the first interval and the second interval comprises determining that the second interval is larger than the first interval.

12. The UE of claim 10, wherein determining the first interval and the second interval is based on receiving a system information block.

13. The UE of claim 10, wherein determining the first interval and the second interval is based on reselection of the first SSB.

14. The UE of claim 10, wherein the one or more processors are further executable to cause the UE to:
determine a paging rate threshold based on a power model and PEI configuration; and
determine a paging decoding rate based on a total paging decoding number and a time window, wherein
enabling PEI monitoring is further based on an evaluation of the paging decode rate relative to the paging rate threshold.

15. The UE of claim 14, wherein the total paging decoding number comprises a number of decoded paging signals corresponding to respective paging occasions.

16. The UE of claim 14, wherein the time window comprises one of more paging cycles, a paging cycle of one or more paging cycles comprising a time between paging occasions.

17. The UE of claim 14, wherein the one or more processors are further executable to cause the UE to:
detect a change to a paging configuration; and
determine the paging rate threshold based on the change to the paging configuration.

18. The UE of claim 10, wherein the one or more processors are further executable to cause the UE to:
initiate a pre-sync timer comprising a duration of one or more paging cycles; and
refrain from decoding the first SSB relative to initiation of the pre-sync timer and prior to the PEI occasion.

19. The UE of claim 18, wherein the one or more processors are further executable to cause the UE to:
decode the second SSB relative to the initiation of the pre-sync timer and the first SSB;
restart the pre-sync timer in response to decoding the second SSB; and
decode a paging signal corresponding to a paging occasion indicated by the second SSB, the paging occasion comprising a first paging occasion of a sequence of paging occasions indicated by the second SSB.

20. Baseband circuitry, comprising:
a memory; and
one or more processors configured to, when executing instructions stored in the memory, cause the baseband circuitry to:
initiate a pre-sync timer comprising a duration for one or more paging cycles;
refrain from decoding a first synchronization signal block (SSB) relative to initiation of the pre-sync timer and prior to a first paging early indication (PEI) occasion;
decode a second SSB relative to the initiation of the pre-sync timer and the first SSB;
restart the pre-sync timer in response to decoding the second SSB; and
decode a paging signal corresponding to a paging occasion indicated by the second SSB, the paging occasion comprising a first paging occasion of a sequence of paging occasions indicated by the second SSB.
